(19) United States
(12) Patent Application Publication
(10) Pub. No.: US 2022/0237780 A1
(43) Pub. Date: Jul. 28, 2022

(54) METHOD FOR DETECTING SERIAL SECTION OF MEDICAL IMAGE

(71) Applicant: VUNO Inc., Seoul (KR)

(72) Inventors: Yeong Won KIM, Seoul (KR); Kyungdoc KIM, Seoul (KR); Hong Seok LEE, Seoul (KR); Jeonghyuk PARK, Seoul (KR)

(21) Appl. No.: 17/586,286

(22) Filed: Jan. 27, 2022

(30) Foreign Application Priority Data
Jan. 28, 2021 (KR) 10-2021-0012162

(51) Int. Cl. G06T 7/00

(52) U.S. Cl. CPC G06T 7/0012; G06T 2207/20084; G06T 2207/20081; G06T 2207/30024

(57) ABSTRACT

Disclosed is a method for detecting a serial section of a medical image, which is performed by a computing device. The method may include: detecting segments included in at least one tissue which exists in the medical image; estimating a number of tissue sections corresponding to the serial section and a distance between the segments based on the segments; and distinguishing tissue sections corresponding to the serial section based on the estimated number of tissue sections corresponding to a serial section and the distance between the segments.

### CROSS-REFERENCE TO RELATED APPLICATIONS

This application claims priority to and the benefit of Korean Patent Application No. 10-2021-0012162 filed in the Korean Intellectual Property Office on Jan. 28, 2021, the entire contents of which are incorporated herein by reference.

### BACKGROUND

### Technical Field

The present disclosure relates to a method for processing a medical image, and more particularly, to a method for analyzing a serial section of a tissue which exists in a medical image for pathological diagnosis.

### Description of the Related Art

A medical image is a material that allows physical states of various tissues of the human body to be understood. The medical mage includes a digital radiographic image (X-ray), a compute tomography (CT), magnetic resonance imaging (MM), a pathology slide image, etc.

In recent years, as digital pathology starts to attract attention in a medical field, development of various technologies for acquiring, processing, and analyzing the pathology slide image even in the medical image has been conducted. The pathology slide image is representatively generated based on a glass slide manufactured for microscope observation. In this case, the tissue is cut and placed in the glass slide in a form of a section. That is, one tissue is constituted by multiple sections to be arranged on the glass slide. Accordingly, multiple sections for at least one tissue may be consecutively arranged and present in the pathology slide image.

Korean Patent Unexamined Publication No. 10-2020-0032651 (Mar. 26, 2020) discloses Apparatus for Three Dimension Image Reconstruction and Method Thereof.

### BRIEF SUMMARY

In related art, due to the aforementioned feature of the pathology slide image, in spite of sections of the same tissue, by recognizing the sections as different tissues, a state of the tissue may be identified. For example, in the related art, even though multiple sections are the same tissue, each section is analyzed as a different cancer tissue to output a reading result. However, the analysis of the related art causes a problem that interferes with accurate diagnosis of a domain expert (e.g., pathology diagnosis medical specialist) and induces misdiagnosis.

The present disclosure has been made in an effort to provide a method for identifying a serial section of a tissue which exists in a medical image for pathological diagnosis. One or more embodiments of the present disclosure resolves one or more technical problems of the related art including the one identified above.

An embodiment of the present disclosure provides a method for detecting a serial section based on a medical image, which is performed by a computing device. The method may include: detecting segments included in at least one tissue which exists in a medical image; estimating the number of tissue sections corresponding to the serial section and a distance between the segments based on the segments; and identifying tissue sections corresponding to the serial section based on the estimated number of tissue sections and the estimated distance between the segments.

In an alternative embodiment, the detecting of the segments may include detecting the segments included in at least one tissue which exists in the medical image by inputting the medical image in a pre-learned deep learning model.

In an alternative embodiment, the detecting of the segments may include determining candidate segments included in at least one tissue which exists in the medical image based on an intensity of the medical image, and determining segments corresponding to a detection object from the candidate segments based on sizes of the candidate segments.

In an alternative embodiment, the estimating of the number of tissue sections and the distance between the segments may include calculating difference values between the segments and an entire region by comparing the respective segments with the entire region of the medical image, extracting at least one local point for each region corresponding to each of the segments based on the sizes of the difference values, and estimating the number of tissue sections corresponding to the serial section based on the local point by considering the sizes of the segments.

In an alternative embodiment, the extracting of the at least one local point may further include determining a point where the sizes of the difference values are equal to or less than a threshold in the entire region of the medical image as the at least one local point.

In an alternative embodiment, the estimating of the number of tissue sections corresponding to the serial section based on the local point may include estimating the number of tissue sections corresponding to the serial section by performing voting for the local point with the size of each of the segments as a weight.

In an alternative embodiment, the estimating of the number of tissue sections and the distance between the segments may include performing geometric transform for the segments, comparing difference values between segments to which the geometrid transform is applied and regions matched by the geometric transform of the segments with each other, and estimating the distance between the segments based on a result of the comparison.

In an alternative embodiment, the estimating of the distance between the segments based on the result of the comparison may include estimating the distance between the segments based on a degree at which difference values between the segments to which the geometrid transform is applied and the regions matched by the geometric transform of the segments correspond to each other.

In an alternative embodiment, the identifying of the tissue sections corresponding to the serial section based on the estimated number of tissue sections and the distance between the segments may include generating a graph based on the distance between the segments, and identifying the tissue sections corresponding to the serial section by splitting the graph based on the estimated number of tissue sections.

In an alternative embodiment, the graph may include a node with the sizes of the segments as the weight, and an edge with the distance between the segments as the weight.

In an alternative embodiment, the identifying of the tissue sections corresponding to the serial section by splitting the graph based on the estimated number of tissue sections may include splitting the graph to suit the estimated number of tissue sections according to the distance between the segments, grouping the segments based on the graph split to suit the estimated number of tissue sections, and identifying each segment group generated through the grouping as one tissue section.

Another embodiment of the present disclosure provides a computer program stored in a computer-readable storage medium. The computer program executes the following operations for detecting a serial section for a medical image when the computer program is executed by one or more processors and the operations may include: detecting segments included in at least one tissue which exists in a medical image; estimating the number of tissue sections corresponding to the serial section and a distance between the segments based on the segments; and identifying tissue sections corresponding to the serial section based on the estimated number of tissue sections and the distance between the segments.

Still another embodiment of the present disclosure provides a device for detecting a serial section for a medical image. The device may include: a processor including at least one core; a memory including program codes executable in the processor; and a network unit receiving a medical image, in which the processor may detect segments included in at least one tissue which exists in a medical image, estimate the number of tissue sections corresponding to the serial section and a distance between the segments based on the segments, and identify tissue sections corresponding to the serial section based on the estimated number of tissue sections and the distance between the segments.

According to an embodiment of the present disclosure, a method for detecting a serial section of a tissue which exists in a medical image for pathological diagnosis can be provided.

### BRIEF DESCRIPTION OF THE SEVERAL VIEWS OF THE DRAWINGS

FIG. 1 is a block diagram of a computing device for detecting a serial section of a medical image according to an embodiment of the present disclosure.

FIG. 2 is a block diagram of a module for detecting a serial section of a computing device according to an embodiment of the present disclosure.

FIG. 3 is a schematic diagram illustrating a network function according to an embodiment of the present disclosure.

FIG. 4 is a conceptual diagram illustrating a process of detecting segments of a computing device according to an embodiment of the present disclosure.

FIGS. 5A and 5B are conceptual diagrams schematizing data derived during a process of estimating the number of tissue sections corresponding to a serial section of a computing device according to an embodiment of the present disclosure.

FIG. 6 is a conceptual diagram schematizing a graph generated to identify tissue sections corresponding to a serial section of a computing device according to an embodiment of the present disclosure.

FIG. 7 is a flowchart illustrating a method for detecting a serial section of a medical image according to an embodiment of the present disclosure.

FIG. 8 is a block diagram of a computing device according to an embodiment of the present disclosure.

### DETAILED DESCRIPTION

Hereinafter, various embodiments are described with reference to the drawings. In the present specification, various descriptions are presented for understanding the present disclosure. However, it is obvious that the embodiments may be carried out even without a particular description.

Terms, “component,” “module,” “system,” and the like used in the present specification indicate a computer-related entity, hardware, firmware, software, a combination of software and hardware, or execution of software. For example, a component may be a procedure executed in a processor, a processor, an object, an execution thread, a program, and/or a computer, but is not limited thereto. For example, both an application executed in a computing device and the computing device may be components. One or more components may reside within a processor and/or an execution thread. One component may be localized within one computer. One component may be distributed between two or more computers. Further, the components may be executed by various computer readable medium having various data structures stored therein. For example, components may communicate through local and/or remote processing according to a signal (for example, data transmitted to another system through a network, such as Internet, through data and/or a signal from one component interacting with another component in a local system and a distributed system) having one or more data packets.

A term “or” intends to mean comprehensive “or,” not exclusive “or.” That is, unless otherwise specified or when it is unclear in context, “X uses A or B” intends to mean one of the natural comprehensive substitutions. That is, when X uses A, X uses B, or X uses both A and B, “X uses A or B” may be applied to any one among the cases. Further, a term “and/or” used in the present specification shall be understood to designate and include all of the possible combinations of one or more items among the listed relevant items.

A term “include” and/or “including” shall be understood as meaning that a corresponding characteristic and/or a constituent element exists. Further, a term “include” and/or “including” means that a corresponding characteristic and/or a constituent element exists, but it shall be understood that the existence or an addition of one or more other characteristics, constituent elements, and/or a group thereof is not excluded. Further, unless otherwise specified or when it is unclear that a single form is indicated in context, the singular shall be construed to generally mean “one or more” in the present specification and the claims.

The term “at least one of A and B” should be interpreted to mean “the case including only A,” “the case including only B,” and “the case where A and B are combined”.

Those skilled in the art shall recognize that the various illustrative logical blocks, configurations, modules, circuits, means, logic, and algorithm operations described in relation to the embodiments additionally disclosed herein may be implemented by electronic hardware, computer software, or in a combination of electronic hardware and computer software. In order to clearly exemplify interchangeability of hardware and software, the various illustrative components, blocks, configurations, means, logic, modules, circuits, and operations have been generally described above in the functional aspects thereof. Whether the functionality is implemented as hardware or software depends on a specific application or design restraints given to the general system. Those skilled in the art may implement the functionality described by various methods for each of the specific applications. However, it shall not be construed that the determinations of the implementation deviate from the range of the contents of the present disclosure.

The description about the presented embodiments is provided so as for those skilled in the art to use or carry out the present disclosure. Various modifications of the embodiments will be apparent to those skilled in the art. General principles defined herein may be applied to other embodiments without departing from the scope of the present disclosure. Therefore, the present disclosure is not limited to the embodiments presented herein. The present disclosure shall be interpreted within the broadest meaning range consistent to the principles and new characteristics presented herein.

In the present specification, a neural network, an artificial neural network, and a network function may often be interchangeably used.

Meanwhile, the term “image” or “image data” used throughout the detailed description and claims of the present disclosure refers to multi-dimensional data constituted by discrete image elements (e.g., pixels in a 2D image), and in other words, refers to an object which may be seen with an eye (e.g., displayed on a video screen) or a digital representation of the object (such as a file corresponding to a pixel output of CT, MRI detector, etc.).

For example, the “image” may be computed tomography (CT), magnetic resonance imaging (MRI), ultrasonic waves, a medical image of a subject collected by any other medical imaging system known in the technical field of the present disclosure. The image may not particularly be provided in a medical context, and may be provided in a non-medical context, and may be for example, a security search X-ray imaging.

Throughout the detailed description and claims of the present disclosure, a ‘Digital Imaging and Communications in Medicine (DICOM)’ standard is a term which collectively refers to several standards used for digital image representation and communication in a medical device, so that the DICOM standard is announced by the Federation Committee, constituted in the American College Radiology (ACR) and the National Electrical Manufacturers Association (NEMA).

Throughout the detailed description and claims of the present disclosure, a Picture Archiving and Communication System (PACS)′ is a term that refers to a system for performing storing, processing, and transmitting according to the DICOM standard, and medical images obtained by using digital medical image equipment such as X-ray, CT, and MRI may be stored in a DICOM format and transmitted to terminals inside or outside a hospital through a network, and additionally include a reading result and a medical chart.

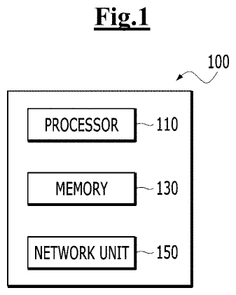

FIG. 1 is a block diagram of a computing device for detecting a serial section of a medical image according to an embodiment of the present disclosure.

A configuration of the computing device 100 illustrated in FIG. 1 is only an example shown through simplification. In an embodiment of the present disclosure, the computing device 100 may include other components for performing a computing environment of the computing device 100 and only some of the disclosed components may constitute the computing device 100.

The computing device 100 may include a processor 110, a memory 130, and a network circuit 150 (hereinafter, also referred to as “a network unit 150”).

The processor 110 may be constituted by one or more cores and may include processors for data analysis and deep learning, which include a central processing unit (CPU), a general purpose graphics processing unit (GPGPU), a tensor processing unit (TPU), and the like of the computing device. The processor 110 may read a computer program stored in the memory 130 to perform data processing for machine learning according to an embodiment of the present disclosure. According to an embodiment of the present disclosure, the processor 110 may perform a calculation for learning the neural network. The processor 110 may perform calculations for learning the neural network, which include processing of input data for learning in deep learning (DL), extracting a feature in the input data, calculating an error, updating a weight of the neural network using backpropagation, and the like. At least one of the CPU, GPGPU, and TPU of the processor 110 may process learning of a network function. For example, both the CPU and the GPGPU may process the learning of the network function and data classification using the network function. Further, in an embodiment of the present disclosure, processors of a plurality of computing devices may be used together to process the learning of the network function and the data classification using the network function. Further, the computer program executed in the computing device according to an embodiment of the present disclosure may be a CPU, GPGPU, or TPU executable program.

The processor 110 according to an embodiment of the present disclosure may detect a serial section of at least one tissue which exists in the medical image. In this case, the medical image may be a pathology slide image including sections for at least one tissue. Further, the serial section may be appreciated as sections generated by serially partitioning one tissue for pathological examination. Since all tissue sections which are the serial section correspond to the same tissue, it is beneficial that the tissue sections are recognized as the same tissue during a process of analyzing the pathology slide image for pathology diagnosis. The processor 110 may serve to identify the serial section which exists in the medical image so that the serial section is recognized as the same tissue. The processor 110 identifies the serial section to increase pathological diagnosis accuracy and efficiency of the tissue. Further, the processor 110 identifies the serial section to increase efficiency of a task of labeling learning data of a deep learning model for the pathological diagnosis of the tissue.

The processor 110 may detect segments for identifying sections for at least one tissue, which exist in the medical image. This case may be a state in which the sections of the tissue, which exist in the medical image are not distinguished as respective objects at a time point when the medical image is received through the network unit 150. Accordingly, the processor 110 may detect the segments included in the tissue in order to identify the sections of the tissue, which exist in the medical image as the individual objects. In this case, the segment may be appreciated as a basic unit of the tissue, which corresponds to an identification target in the medical image.

The processor 110 may estimate the number of sections corresponding to serial section of a specific tissue, which exist in the medical image. The processor 110 may identify a partial region of the medical image, which is similar to a specific segment through comparison with an entire region of the medical image based on a specific segment. The processor 110 performs the similar region identification for all segments, and then aggregate an identification result to estimate the number of tissue sections corresponding to the serial section.

The processor 110 estimates a distance between the segments to distinguish in which tissue section the segments which exist in the medical image are included. The processor 110 may define the distance between the segments. In this case, the distance as a unit representing a relationship between the segments may be expressed while being replaced with cost, loss, or energy in a range which may be appreciated by those skilled in the art. The processor 110 may determine which segments are included in one section by considering a neighboring degree of the distance between the segments. In other words, the processor 110 may determine whether the segments belong to the same section or different sections by determine the relationship between the segments.

The processor 110 may identify sections corresponding to the serial section of the specific tissue based on the number of tissue sections corresponding to the serial section and the distance between the segments. The processor 110 may generate a graph based on each of the segments. The processor 110 may distinguish the sections corresponding to the serial section of the specific tissue by splitting the graph based on features of the segments. The processor 110 may represent each of the sections corresponding to the serial section of the specific tissue as a bounding box in the medical image. The bounding box may be appreciated as any form of geometric structure capable of encompassing a specific form of object. The processor 110 may split each of the sections corresponding to the serial section of the specific tissue on the medical image and extract the split sections as separate images.

According to an embodiment of the present disclosure, the memory 130 may store any type of information generated or determined by the processor 110 and any type of information received by the network unit 150.

According to an embodiment of the present disclosure, the memory 130 may include at least one type of storage medium of a flash memory type storage medium, a hard disk type storage medium, a multimedia card micro type storage medium, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. The computing device 100 may operate in connection with a web storage performing a storing function of the memory 130 on the Internet. The description of the memory is just an example and the present disclosure is not limited thereto.

The network unit 150 according to an embodiment of the present disclosure may use an arbitrary type wired/wireless communication systems.

The network unit 150 may receive a medical image representing a physical tissue from a medical image storage and transmission system. For example, the medical image representing the physical tissue may be learning data or inference data of the neural network model. The medical image representing the physical tissue may be a pathology slide image including at least one tissue. In this case, the pathology slide image may be appreciated as a scan image obtained from the glass slide through a scanner and stored in the medical image storage and transmission system for pathology diagnosis. The medical image representing the physical tissue is not limited to the above-described example, but may include all images related to the physical tissue acquired through photographing, such as an X-ray image, a CT image, etc.

The network unit 150 may transmit and receive information processed by the processor 110, a user interface, etc., through communication with the other terminal. For example, the network unit 150 may provide the user interface generated by the processor 110 to a client (e.g., a user terminal). Further, the network unit 150 may receive an external input of a user applied to the client and deliver the received external input to the processor 110. In this case, the processor 110 may process operations such as output, modification, change, addition, etc., of information provided through the user interface based on the external input of the user delivered from the network unit 150.

Meanwhile, according to an embodiment of the present disclosure, the computing device 100 as a computing system that transmits and receives information to and from the client through communication may include a server. In this case, the client may be any type of terminal which may access the server. For example, the computing device 100 which is the server may receive the medical image from the medical image photographing system and analyze the lesion, and provide a user interface including an analysis result to the user terminal. In this case, the user terminal may output the user interface received from the computing device 100 as the server, and receive and process the information through an interaction with the user.

In an additional embodiment, the computing device 100 may also include any type of terminal that performs additional information processing by receiving a data resource generated in any server.

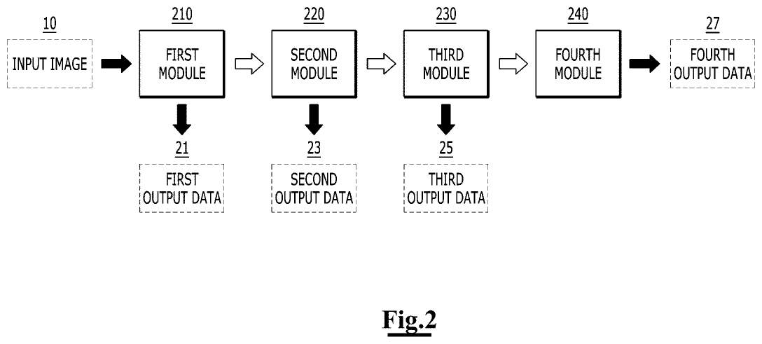

FIG. 2 is a block diagram of a module for detecting a serial section of a computing device according to an embodiment of the present disclosure.

Referring to FIG. 2, the processor 110 of the computing device 100 according to an embodiment of the present disclosure may include a first module 210 detecting an interested object which exists in an input image 10. The first module 210 may generate information on the interested object which exists in the input image 10 as first output data 21. In this case, the input image 10 may be a pathology slide image in which sections for at least one tissue are arranged. The interested object may be a segment included in at least one tissue which exists in the pathology slide image. The first output data 21 may be a mask including meta information (e.g., positional information, size information, etc.) for each segment. The first output data 21 may also be provided to a user terminal through a user interface.

The first module 210 may recognize candidate segments included in at least one tissue which exists in the input image 10 based on an intensity of the input image 10. In this case, the intensity of the input image 10 may be appreciated as an intensity of an indicator related to object representation of the image, such as a color, a brightness, etc., of the input image 10. The first module 210 may determine segments corresponding to a detection object from the candidate segments based on sizes of the candidate segments. For example, the first module 210 may reduce the input image 10 to a size which is easy to compute. The first module 210 may calculate a color intensity of the reduced input image, and compare the calculated color intensity with a first threshold. In this case, the first threshold may be predetermined based on a background of the reduced input image. The first module 210 may recognize a region where a calculation value of the color intensity is less than the first threshold as the candidate segment of the tissue. Since too small sized candidate segments cause computation amounts of the modules 210 to 240 to be increased, the first module 210 may determine segments corresponding to a final detection object by considering the sizes of the candidate segments. The first module 210 may determine the remaining candidate segments except for at least one candidate segment in which a size is less than a second threshold among the candidate segments as the final detection object. The second threshold may be predetermined by considering capabilities of the first module 210 and the remaining modules 220 to 240 to be described below.

The first module 210 may also include a pre-learned deep learning model. For example, the pre-learned deep learning model may include a convolution neural network capable of performing object detection segmentation, etc., regardless of a size of an input. The disclosure related to the neural network is just one example, and is not limited thereto, and is changeable within a scope which may be appreciated those skilled in the art. The first module 210 may detect the segments included in at least one tissue which exists in the input image 10 by using the pre-learned deep learning model. In this case, the first module 210 may reduce the input image 10 to a size which is easy to facilitate the computation by the model before using the deep learning model. Further, the first module 210 may determine one of the segments as the final detection object by considering the sizes of the segments as postprocessing for the segments detected through the deep learning model.

The processor 110 may include a second module 220 that calculates the number of groups including the interested object by receiving the output data of the first module 210. The second module 220 may generate information on the number of groups including the interested object which exists in the input image 10 as second output data 23. In this case, the output data of the first module 210 may be a data aggregate including meta information regarding the segment detected by the first module 210. The group including the interested object may be appreciated as a tissue section corresponding to the serial section of a specific tissue which exists in the pathology slide. The second output data 23 may also be provided to the user terminal through the user interface.

The second module 220 may calculate difference values between the segments and the entire region by comparing each of the segments detected through the first module 210 and the entire region of the input image 10. For example, the second module 220 may compare one patch including one segment detected through the first module 210 with all regions constituting the input image 10 based on the color intensity. The second module 220 may calculate difference values between the color intensity of one segment and color intensities of all regions constituting the input image 10. The second module 220 may calculate different values between the remaining segments and all images of the input image 10. That is, if N (N is a natural number) segments are detected by the first module 210, the second module 220 may calculate N difference values for N segments, respectively. Through such a process, the second module 220 may generate maps representing difference values between all segments detected by the first module 210 and the input image 10.

The second module 220 may extract at least one local point for each of regions corresponding to the segments, respectively based on the sizes of the difference values between the segments and the entire region of the input image 10. In this case, the regions corresponding to the segments, respectively may be appreciated as one region of the input image 10 including a point where the size of the difference value between the segment and the color intensity is the smallest. Further the local point may be appreciated as a point which exists in the input image 10 in which the difference value between the segment and the color intensity is equal to or less than a third threshold. For example, the second module 220 may determine the point where the difference value is equal to or less than the third threshold as at least one first local point based on a first map representing the difference value between the first segment and the color intensity the input image 10. The second module 220 may determine the point where the difference value is equal to or less than the third threshold as at least one second local point based on a second map representing the difference value between the second segment and the color intensity the input image 10. The second module 220 may determine the point where the difference value is equal to or less than the third threshold as at least one N-th local point based on an N-th map representing the difference value between an N-th segment and the color intensity the input image 10. In this case, the third threshold may be one numerical value unified to be commonly applied to all segments. The third threshold may also include a plurality of numerical values distinguished by considering the color intensity of each of the segments.

The second module 220 may estimate the number of tissue sections corresponding to the serial section based on the local point by considering the sizes of the segments. The second module 220 may estimate the number of tissue sections corresponding to the serial section by performing voting for the local point by setting the size of each of the segments as a weight. For example, the second module 220 may aggregate the numbers of local points of the respective segments by considering the sizes of the respective segments as the weight. The second module 220 may grant a high weight to a segment having a relatively large segment, grant a low weight to a relatively small segment, and aggregate the numbers of local points of the respective segments to which the weight is granted according to the size. In this case, the aggregation may be appreciated as a weighted voting operation such as an average operation considering the weight. The second module 220 may estimate the number of local points for all segments derived by an aggregation result as the number of tissue sections corresponding to the serial section.

The processor 110 may include a third module 230 that calculates the distance between the interested object by receiving the output data of the first and second modules 210 and 220. The third module 230 may generate the information on the distance between the interested object which exist in the input image 10 as third output data 25. The third output data 25 may also be provided to the user terminal through the user interface.

The third module 230 may estimate the distance between the segments in order to identify the tissue sections to which the respective segments are to be included. For example, the third module 230 may estimate a Euclidean distance between the segments. In this case, the Euclidean distance may be a numerical value computed based on a 1 dimension or a 2 dimension.

The third module 230 may also estimate the distance between the segments by performing relative geometric transform between the segments. Specifically, the third module 230 may perform geometric transform for one segment. In this case, the geometric transform may include coordinate movement on the 2 dimension. The third module 230 may derive a difference value between one segment to which the geometric transform is applied and a region matched by the geometric transform of one segment. In this case, the third module 230 may use a map for a difference value pre-derived through the second module 220. The third module 230 may derive difference value from the region matched by the geometric transform by performing the same operation as described above even for the remaining segments. The third module 230 may compute the distance between the segments by comparing difference values between the segment and the matched region. The third module 230 may estimate the distance between the segments based on a degree at which the difference values between the segments to which the geometric transform is applied and the region matched by the geometric transform of the segments correspond to each other. If two segments are included in the same section, there is a high possibility that the difference value from the matched region of one segment to which the geometric transform is applied will significantly match a difference value between another segment to which the geometric transform is applied and the matched region. On the contrary, if two segments are included in different sections, there is a high possibility that the difference value from the matched region of one segment to which the geometric transform is applied will be significantly different from the difference value between another segment to which the geometric transform is applied and the matched region. Accordingly, the third module 230 may determine that the distance between the segments is closer as the correspondence degree of the difference values derived according to the geometric transform is higher. On the contrary, the third module 230 may determine that the distance between the segments is longer as the correspondence degree of the difference values derived according to the geometric transform is lower. The higher and lower correspondence degrees may also be determined through a comparative comparison of values derived through a total operation, and determined according to a predetermined reference value. As such, the third module 230 may define the distance between the segments by determining the higher and lower correspondence degrees of the difference values.

The processor 110 may include a fourth module 240 that classifies groups including the interested objects by receiving the output data of the second and third modules 220 and 230. The fourth module 240 may generate fourth output data 27 based on classification information of the groups including the interested object which exists in the input image 10. In this case, the information on the groups including the interested objects included in the fourth output data 27 may be appreciated as information on the tissue sections corresponding to the serial section of the specific tissue, which are distinguished from each other by the fourth module 240. For example, the fourth output data 27 may include image data in which each of the tissue sections corresponding to the serial section of the specific tissue is marked by a bounding box, split image data of each of the tissue sections corresponding to the serial section, etc. The fourth output data 27 may be used as an input of an analysis system for the pathology analysis. Further, the fourth output data 27 may also be provided to the user terminal through the user interface.

The fourth module 240 may distinguish the tissue sections corresponding to the serial section of the specific tissue from each other based on the number of tissue sections corresponding to the serial section derived through the second module 220 and the distance between the segments derived through the third module 230. For example, the fourth module 240 may generate a graph based on the distance between the segments. In this case, the graph may include an edge with distances between a node having the sizes of the segments as the weight, and the segments as the weight. In order to increase analysis accuracy of a segment which is difficult to distinguish due to a small size, the fourth module 240 may generate a node having the size of the segment as the weight of the node as compared with the number of image pixels. The fourth module 240 may identify the tissue sections corresponding to the serial section by splitting the graph based on the number of tissue sections. When it is assumed that there are three sections corresponding to a serial section of a prostate tissue, the fourth module 240 may distinguish each of three sections as an individual object by splitting the graph generated based on the segments.

Specifically, the fourth module 240 may distinguish the graph according to the number of tissue sections corresponding to the serial section according to the distance between the segments. The fourth module 240 preferentially identifies that the distance between the segments is long based on the number of tissue sections corresponding to the serial section to split an entire graph according to the number of tissue sections corresponding to the serial section. The fourth module 240 may group the segments based on the graph split according to the number of tissue sections. The fourth module 240 may distinguish the tissue sections corresponding to the serial section as the individual objects by determining each of the segment groups generated through grouping as one tissue section. When it is assumed that three segment groups are generated by the grouping of the segments, the fourth module 240 determines each of three segment groups as the tissue section to identify tissue sections corresponding to a total of three serial sections. In other words, the fourth module 240 determines the segment group as the tissue section to identify the tissue sections corresponding to the serial section of the specific tissue as three individual objects. By such a process, the fourth module 240 may determine the segments tied by one group as one tissue section and identify the tissue sections corresponding to the serial section.

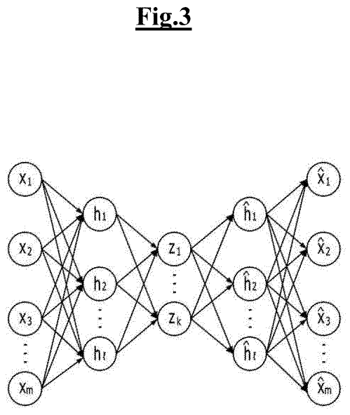

FIG. 3 is a schematic diagram illustrating a network function according to an embodiment of the present disclosure.

Throughout the present disclosure, a deep learning model, the neural network, a network function, and the neural network may be used as an interchangeable meaning. The neural network may be generally constituted by an aggregate of calculation units which are mutually connected to each other, which may be called nodes. The nodes may also be called neurons. The neural network is configured to include one or more nodes. The nodes (alternatively, neurons) constituting the neural networks may be connected to each other by one or more links.

In the neural network, one or more nodes connected through the link may relatively form the relationship between an input node and an output node. Concepts of the input node and the output node are relative and a predetermined node which has the output node relationship with respect to one node may have the input node relationship in the relationship with another node and vice versa. As described above, the relationship of the input node to the output node may be generated based on the link. One or more output nodes may be connected to one input node through the link and vice versa.

In the relationship of the input node and the output node connected through one link, a value of data of the output node may be determined based on data input in the input node. Here, a link connecting the input node and the output node to each other may have a weight. The weight may be variable and the weight is variable by a user or an algorithm in order for the neural network to perform a desired function. For example, when one or more input nodes are mutually connected to one output node by the respective links, the output node may determine an output node value based on values input in the input nodes connected with the output node and the weights set in the links corresponding to the respective input nodes.

As described above, in the neural network, one or more nodes are connected to each other through one or more links to form a relationship of the input node and output node in the neural network. A characteristic of the neural network may be determined according to the number of nodes, the number of links, correlations between the nodes and the links, and values of the weights granted to the respective links in the neural network. For example, when the same number of nodes and links exist and there are two neural networks in which the weight values of the links are different from each other, it may be recognized that two neural networks are different from each other.

The neural network may be constituted by a set of one or more nodes. A subset of the nodes constituting the neural network may constitute a layer. Some of the nodes constituting the neural network may constitute one layer based on the distances from the initial input node. For example, a set of nodes of which distance from the initial input node is n may constitute n layers. The distance from the initial input node may be defined by the minimum number of links which should be passed through for reaching the corresponding node from the initial input node. However, definition of the layer is predetermined for description and the order of the layer in the neural network may be defined by a method different from the aforementioned method. For example, the layers of the nodes may be defined by the distance from a final output node.

The initial input node may mean one or more nodes in which data is directly input without passing through the links in the relationships with other nodes among the nodes in the neural network. Alternatively, in the neural network, in the relationship between the nodes based on the link, the initial input node may mean nodes which do not have other input nodes connected through the links. Similarly thereto, the final output node may mean one or more nodes which do not have the output node in the relationship with other nodes among the nodes in the neural network. Further, a hidden node may mean nodes constituting the neural network other than the initial input node and the final output node.

In the neural network according to an embodiment of the present disclosure, the number of nodes of the input layer may be the same as the number of nodes of the output layer, and the neural network may be a neural network of a type in which the number of nodes decreases and then, increases again from the input layer to the hidden layer. Further, in the neural network according to another embodiment of the present disclosure, the number of nodes of the input layer may be smaller than the number of nodes of the output layer, and the neural network may be a neural network of a type in which the number of nodes decreases from the input layer to the hidden layer. Further, in the neural network according to still another embodiment of the present disclosure, the number of nodes of the input layer may be larger than the number of nodes of the output layer, and the neural network may be a neural network of a type in which the number of nodes increases from the input layer to the hidden layer. The neural network according to yet another embodiment of the present disclosure may be a neural network of a type in which the neural networks are combined.

A deep neural network (DNN) may refer to a neural network that includes a plurality of hidden layers in addition to the input and output layers. When the deep neural network is used, the latent structures of data may be determined. That is, latent structures of photos, text, video, voice, and music (e.g., what objects are in the photo, what the content and feelings of the text are, what the content and feelings of the voice are) may be determined. The deep neural network may include a convolutional neural network, a recurrent neural network (RNN), an auto encoder, generative adversarial networks (GAN), a restricted Boltzmann machine (RBM), a deep belief network (DBN), a Q network, a U network, a Siam network, a generative adversarial network (GAN), and the like. The description of the deep neural network described above is just an example and the present disclosure is not limited thereto.

In an embodiment of the present disclosure, the network function may include the auto encoder. The auto encoder may be a kind of artificial neural network for outputting output data similar to input data. The auto encoder may include at least one hidden layer and odd hidden layers may be disposed between the input and output layers. The number of nodes in each layer may be reduced from the number of nodes in the input layer to an intermediate layer called a bottleneck layer (encoding), and then expanded symmetrical to reduction to the output layer (symmetrical to the input layer) in the bottleneck layer. The auto encoder may perform non-linear dimensional reduction. The number of input and output layers may correspond to a dimension after preprocessing the input data. The auto encoder structure may have a structure in which the number of nodes in the hidden layer included in the encoder decreases as a distance from the input layer increases. When the number of nodes in the bottleneck layer (a layer having a smallest number of nodes positioned between an encoder and a decoder) is too small, a sufficient amount of information may not be delivered, and as a result, the number of nodes in the bottleneck layer may be maintained to be a specific number or more (e.g., half of the input layers or more).

The neural network may be learned in at least one scheme of supervised learning, unsupervised learning, semi supervised learning, or reinforcement learning. The learning of the neural network may be a process in which the neural network applies knowledge for performing a specific operation to the neural network.

The neural network may be learned in a direction to reduce or minimize errors of an output. The learning of the neural network is a process of repeatedly inputting learning data into the neural network and calculating the output of the neural network for the learning data and the error of a target and back-propagating the errors of the neural network from the output layer of the neural network toward the input layer in a direction to reduce the errors to update the weight of each node of the neural network. In the case of the supervised learning, the learning data labeled with a correct answer is used for each learning data (e.g., the labeled learning data) and in the case of the unsupervised learning, the correct answer may not be labeled in each learning data. That is, for example, the learning data in the case of the supervised learning related to the data classification may be data in which category is labeled in each learning data. The labeled learning data is input to the neural network, and the error may be calculated by comparing the output (category) of the neural network with the label of the learning data. As another example, in the case of the unsupervised learning related to the data classification, the learning data as the input is compared with the output of the neural network to calculate the error. The calculated error is back-propagated in a reverse direction (e.g., a direction from the output layer toward the input layer) in the neural network and connection weights of respective nodes of each layer of the neural network may be updated according to the back propagation. A variation amount of the updated connection weight of each node may be determined according to a learning rate. Calculation of the neural network for the input data and the back-propagation of the error may constitute a learning cycle (epoch). The learning rate may be applied differently according to the number of repetition times of the learning cycle of the neural network. For example, in an initial stage of the learning of the neural network, the neural network ensures a certain level of performance quickly by using a high learning rate, thereby increasing efficiency and uses a low learning rate in a latter stage of the learning, thereby increasing accuracy.

In learning of the neural network, the learning data may be generally a subset of actual data (e.g., data to be processed using the learned neural network), and as a result, there may be a learning cycle in which errors for the learning data decrease, but the errors for the actual data increase. Overfitting is a phenomenon in which the errors for the actual data increase due to excessive learning of the learning data. For example, a phenomenon in which the neural network that learns a cat by showing a yellow cat sees a cat other than the yellow cat and does not recognize the corresponding cat as the cat may be a kind of overfitting. The overfitting may act as a cause which increases the error of the machine learning algorithm. Various optimization methods may be used in order to prevent the overfitting. In order to prevent the overfitting, a method such as increasing the learning data, regularization, dropout of omitting a part of the node of the network in the process of learning, utilization of a batch normalization layer, etc., may be applied.

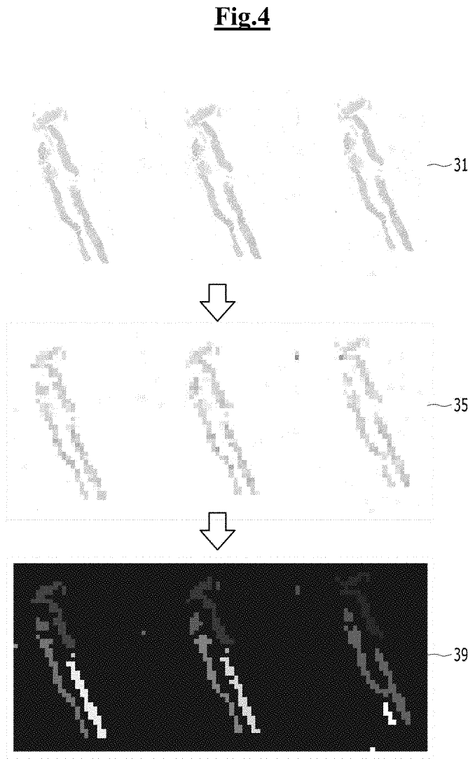

FIG. 4 is a conceptual diagram illustrating a process of detecting segments of a computing device according to an embodiment of the present disclosure.

Referring to FIG. 4, a computing device 100 according to an embodiment of the present disclosure may receive a medical image 31 representing three sections corresponding to a serial section of a specific tissue. When receiving the medical image 31, the computing device 100 may generate a reduced image 35 acquired by transforming the medical image 31 according to a ratio so as to facilitate an operation of the processor 110. The computing device 100 may generate a detected image 39 by identifying segments included in three sections, respectively based on the reduced image 35. In this case, the computing device 100 may identify segments included in three sections, respectively based on a deep learning algorithm. Further, the computing device 100 may also identify the segments included in three sections, respectively based on an intensity (e.g., a color intensity, a brightness intensity, etc.) of the reduced image 35. Although not illustrated in FIG. 4, the computing device 100 may exclude segments which are difficult to identify in the detected image 39 from a final detection object.

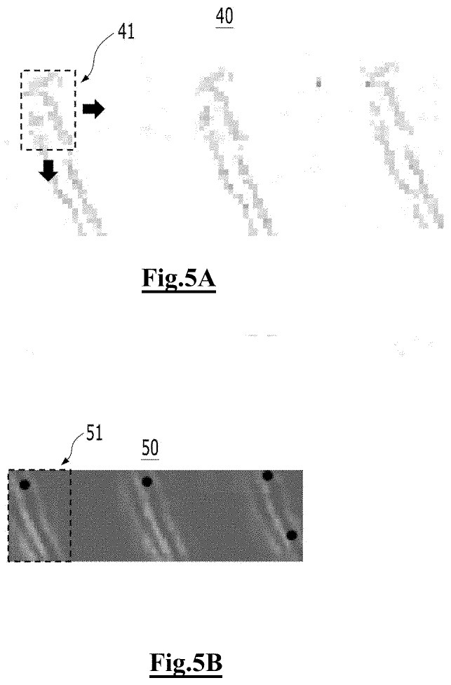

FIGS. 5A and 5B are conceptual diagrams schematizing data derived during a process of estimating the number of tissue sections corresponding to a serial section of a computing device according to an embodiment of the present disclosure.

The computing device 100 according to an embodiment of the present disclosure may calculate difference values between a patch and an entire region of an image 40 while moving a patch 41 including one segment in an image 40 in which the segments are detected. The patch 41 may be a box form as in FIG. 5A, and a form which matches a boundary of one segment in order to increase accuracy of computation of a difference value. The computing device 100 may calculate difference values between the segments and an entire region by defining patches corresponding to all segments which exist in the detected image 40, respectively. The computing device 100 may derive a result of computing difference values between one segment 51 and the entire region of the detected image 40 as a form of a map 50 illustrated in FIG. 5B. In this case, in the map 50 representing difference values between one segment 51 and regions constituting the image, local points corresponding to points where the difference values are smaller than a specific threshold may be displayed.

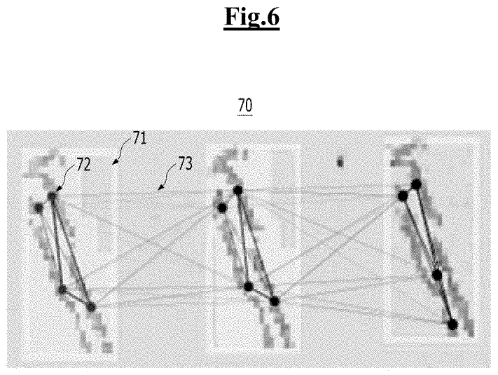

FIG. 6 is a conceptual diagram schematizing a graph generated to identify tissue sections corresponding to a serial section of a computing device according to an embodiment of the present disclosure.

Referring to FIG. 6, the computing device 100 according to an embodiment of the present disclosure may generate a graph with each of segments as a node 72 in order to distinguish three tissue sections corresponding to a serial section. In this case, the graph may include an edge 73 with distances between a node 72 having the sizes of the segments as the weight, and the segments as the weight. The computing device 100 may individually identify three tissue sections by distinguishing graphs based on a distance between the segments. Each of three tissue sections distinguished based on the distance between the segments may be displayed as a bounding box 71 and distinguished in a medical image 70. Each of three tissue sections distinguished by the bounding box 71 may be generated as a separate split image.

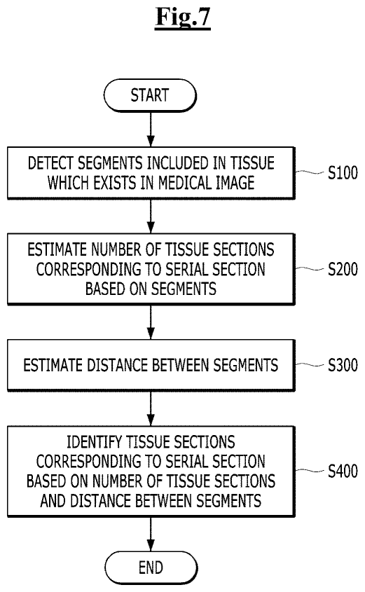

FIG. 7 is a flowchart illustrating a method for detecting a serial section of a medical image according to an embodiment of the present disclosure.

Referring to FIG. 7, in step S100, a computing device 100 according to an embodiment of the present disclosure may receive a medical image from a medical image storage and transmission system. The medical image may be a pathology slide image including sections for at least one tissue. The computing device 100 may detect segments of a tissue to be identified for detecting a serial section by receiving the medical image. For example, the computing device 100 may detect segments of a specific tissue based on a result of comparing an intensity of a unit (e.g., a pixel, etc.) constituting the image with a threshold. Further, the computing device 100 may also detect the segments of the specific tissue by using a deep learning model receiving the medical image.

In step S200, the computing device 100 may calculate the number of sections corresponding to a serial section of the specific tissue based on the segments detected through step S100. For example, the computing device 100 may calculate difference values between a patch including one segment and all regions of the medical image. The computing device 100 may identify a local point based on the difference values between the patch including one segment and all regions of the medical image. The computing device 100 may perform a computation process for derivation of the difference value and identification of the local point for all segments. The computing device 100 may determine the number of local points estimated by considering sizes of segments as the number of sections included in the serial section of the specific tissue.

In step S300, the computing device 100 may compute the distance between the segments in order to check whether the segments detected through step S100 are included in the same section. For example, the computing device 100 may estimate the distance between the segments by computing a Euclidean distance. Further, the computing device 100 may also estimate the distance between the segments by considering a matching degree of the segments according to relative geometric transform. In this case, in order to determine the matching degree between the segments to which the geometric transform is applied, the computing device 100 may use the difference values computed in step S200.

In step S400, the computing device 100 may identify the sections corresponding to the serial section based on the number of sections corresponding to the serial section derived through step S200 and the distance between the segments computed through step S300. For example, the computing device 100 may generate a graph based on the distance between the segments. The computing device 100 may split the graph according to the distance between the segments by considering the number of sections corresponding to the serial section. The computing device 100 may split the graph according to the number of sections corresponding to the serial section by preferentially identifying segments in which the distance between the segments is long. The computing device 100 may group the graphs split through the above-described process, and individually identify the sections corresponding to the serial section by making each group correspond to the section. Information on the tissue sections corresponding to the serial section individually identified through the computing device 100 may be variously used as learning data, inference data, etc., of the model for pathology diagnosis.

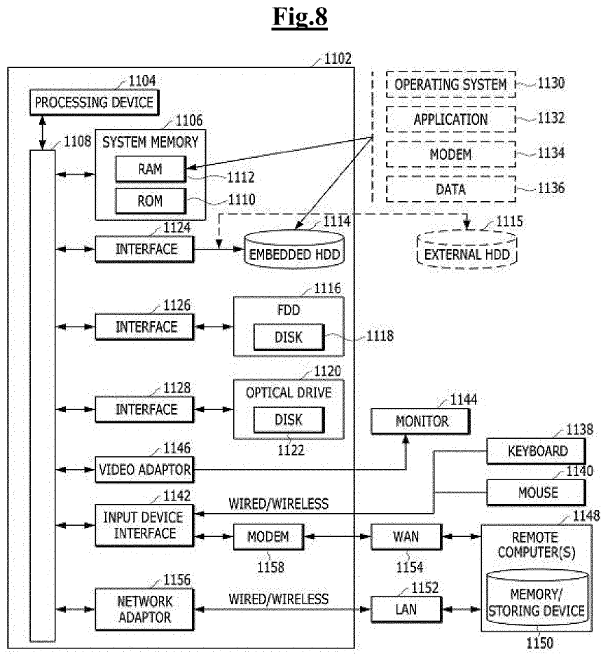

FIG. 8 is a simple and normal schematic view of a computing environment in which the embodiments of the present disclosure may be implemented.

It is described above that the present disclosure may be generally implemented by the computing device, but those skilled in the art will well know that the present disclosure may be implemented in association with a computer executable command which may be executed on one or more computers and/or in combination with other program modules and/or as a combination of hardware and software.

In general, the program module includes a routine, a program, a component, a data structure, and the like that execute a specific task or implement a specific abstract data type. Further, it will be well appreciated by those skilled in the art that the method of the present disclosure can be implemented by other computer system configurations including a personal computer, a handheld computing device, microprocessor-based or programmable home appliances, and others (the respective devices may operate in connection with one or more associated devices as well as a single-processor or multi-processor computer system, a mini computer, and a main frame computer.

The embodiments described in the present disclosure may also be implemented in a distributed computing environment in which predetermined (or selected) tasks are performed by remote processing devices connected through a communication network. In the distributed computing environment, the program module may be positioned in both local and remote memory storage devices.

The computer generally includes various computer readable media. Media accessible by the computer may be computer readable media regardless of types thereof and the computer readable media include volatile and non-volatile media, transitory and non-transitory media, and mobile and non-mobile media. As a non-limiting example, the computer readable media may include both computer readable storage media and computer readable transmission media. The computer readable storage media include volatile and non-volatile media, temporary and non-temporary media, and movable and non-movable media implemented by a predetermined (or selected) method or technology for storing information such as a computer readable instruction, a data structure, a program module, or other data. The computer readable storage media include a RAM, a ROM, an EEPROM, a flash memory or other memory technologies, a CD-ROM, a digital video disk (DVD) or other optical disk storage devices, a magnetic cassette, a magnetic tape, a magnetic disk storage device or other magnetic storage devices or predetermined (or selected) other media which may be accessed by the computer or may be used to store desired information, but are not limited thereto.

The computer readable transmission media generally implement the computer readable command, the data structure, the program module, or other data in a carrier wave or a modulated data signal such as other transport mechanism and include all information transfer media. The term “modulated data signal” means a signal obtained by configuring or changing at least one of characteristics of the signal so as to encode information in the signal. As a non-limiting example, the computer readable transmission media include wired media such as a wired network or a direct-wired connection and wireless media such as acoustic, RF, infrared and other wireless media. A combination of any media among the aforementioned media is also included in a range of the computer readable transmission media.

An environment 1100 that implements various aspects of the present disclosure including a computer 1102 is shown and the computer 1102 includes a processing device 1104, a system memory 1106, and a system bus 1108. The system bus 1108 connects system components including the system memory 1106 (not limited thereto) to the processing device 1104. The processing device 1104 may be a predetermined (or selected) processor among various commercial processors. A dual processor and other multi-processor architectures may also be used as the processing device 1104.

The system bus 1108 may be any one of several types of bus structures which may be additionally interconnected to a local bus using any one of a memory bus, a peripheral device bus, and various commercial bus architectures. The system memory 1106 includes a read only memory (ROM) 1110 and a random access memory (RAM) 1112. A basic input/output system (BIOS) is stored in the non-volatile memories 1110 including the ROM, the EPROM, the EEPROM, and the like and the BIOS includes a basic routine that assists in transmitting information among components in the computer 1102 at a time such as in-starting. The RAM 1112 may also include a high-speed RAM including a static RAM for caching data, and the like.

The computer 1102 also includes an interior hard disk drive (HDD) 1114 (for example, EIDE and SATA), in which the interior hard disk drive 1114 may also be configured for an exterior purpose in an appropriate chassis (not illustrated), a magnetic floppy disk drive (FDD) 1116 (for example, for reading from or writing in a mobile diskette 1118), and an optical disk drive 1120 (for example, for reading a CD-ROM disk 1122 or reading from or writing in other high-capacity optical media such as the DVD, and the like). The hard disk drive 1114, the magnetic disk drive 1116, and the optical disk drive 1120 may be connected to the system bus 1108 by a hard disk drive interface 1124, a magnetic disk drive interface 1126, and an optical drive interface 1128, respectively. An interface 1124 for implementing an exterior drive includes at least one of a universal serial bus (USB) and an IEEE 1394 interface technology or both of them.

The drives and the computer readable media associated therewith provide non-volatile storage of the data, the data structure, the computer executable instruction, and others. In the case of the computer 1102, the drives and the media correspond to storing of predetermined (or selected) data in an appropriate digital format. In the description of the computer readable media, the mobile optical media such as the HDD, the mobile magnetic disk, and the CD or the DVD are mentioned, but it will be well appreciated by those skilled in the art that other types of media readable by the computer such as a zip drive, a magnetic cassette, a flash memory card, a cartridge, and others may also be used in an operating environment and further, the predetermined (or selected) media may include computer executable commands for executing the methods of the present disclosure.

Multiple program modules including an operating system 1130, one or more application programs 1132, other program module 1134, and program data 1136 may be stored in the drive and the RAM 1112. All or some of the operating system, the application, the module, and/or the data may also be cached in the RAM 1112. It will be well appreciated that the present disclosure may be implemented in operating systems which are commercially usable or a combination of the operating systems.

A user may input instructions and information in the computer 1102 through one or more wired/wireless input devices, for example, pointing devices such as a keyboard 1138 and a mouse 1140. Other input devices (not illustrated) may include a microphone, an IR remote controller, a joystick, a game pad, a stylus pen, a touch screen, and others. These and other input devices are often connected to the processing device 1104 through an input device interface 1142 connected to the system bus 1108, but may be connected by other interfaces including a parallel port, an IEEE 1394 serial port, a game port, a USB port, an IR interface, and others.

A monitor 1144 or other types of display devices are also connected to the system bus 1108 through interfaces such as a video adapter 1146, and the like. In addition to the monitor 1144, the computer generally includes other peripheral output devices (not illustrated) such as a speaker, a printer, others.

The computer 1102 may operate in a networked environment by using a logical connection to one or more remote computers including remote computer(s) 1148 through wired and/or wireless communication. The remote computer(s) 1148 may be a workstation, a computing device computer, a router, a personal computer, a portable computer, a micro-processor based entertainment apparatus, a peer device, or other general network nodes and generally includes multiple components or all of the components described with respect to the computer 1102, but only a memory storage device 1150 is illustrated for brief description. The illustrated logical connection includes a wired/wireless connection to a local area network (LAN) 1152 and/or a larger network, for example, a wide area network (WAN) 1154. The LAN and WAN networking environments are general environments in offices and companies and facilitate an enterprise-wide computer network such as Intranet, and all of them may be connected to a worldwide computer network, for example, the Internet.

When the computer 1102 is used in the LAN networking environment, the computer 1102 is connected to a local network 1152 through a wired and/or wireless communication network interface or an adapter 1156. The adapter 1156 may facilitate the wired or wireless communication to the LAN 1152 and the LAN 1152 also includes a wireless access point installed therein in order to communicate with the wireless adapter 1156. When the computer 1102 is used in the WAN networking environment, the computer 1102 may include a modem 1158 or has other means that configure communication through the WAN 1154 such as connection to a communication computing device on the WAN 1154 or connection through the Internet. The modem 1158 which may be an internal or external and wired or wireless device is connected to the system bus 1108 through the serial port interface 1142. In the networked environment, the program modules described with respect to the computer 1102 or some thereof may be stored in the remote memory/storage device 1150. It will be well known that an illustrated network connection is and other means configuring a communication link among computers may be used.

The computer 1102 performs an operation of communicating with predetermined (or selected) wireless devices or entities which are disposed and operated by the wireless communication, for example, the printer, a scanner, a desktop and/or a portable computer, a portable data assistant (PDA), a communication satellite, predetermined (or selected) equipment or place associated with a wireless detectable tag, and a telephone. This at least includes wireless fidelity (Wi-Fi) and Bluetooth wireless technology. Accordingly, communication may be a predefined structure like the network in the related art or just ad hoc communication between at least two devices.

The wireless fidelity (Wi-Fi) enables connection to the Internet, and the like without a wired cable. The Wi-Fi is a wireless technology such as the device, for example, a cellular phone which enables the computer to transmit and receive data indoors or outdoors, that is, anywhere in a communication range of a base station. The Wi-Fi network uses a wireless technology called IEEE 802.11(a, b, g, and others) in order to provide safe, reliable, and high-speed wireless connection. The Wi-Fi may be used to connect the computers to each other or the Internet and the wired network (using IEEE 802.3 or Ethernet). The Wi-Fi network may operate, for example, at a data rate of 11 Mbps (802.11a) or 54 Mbps (802.11b) in unlicensed 2.4 and 5 GHz wireless bands or operate in a product including both bands (dual bands).

It will be appreciated by those skilled in the art that information and signals may be expressed by using various different predetermined (or selected) technologies and techniques. For example, data, instructions, commands, information, signals, bits, symbols, and chips which may be referred in the above description may be expressed by voltages, currents, electromagnetic waves, magnetic fields or particles, optical fields or particles, or predetermined (or selected) combinations thereof.

It may be appreciated by those skilled in the art that various logical blocks, modules, processors, means, circuits, and algorithm steps described in association with the embodiments disclosed herein may be implemented by electronic hardware, various types of programs or design codes (for easy description, herein, designated as software), or a combination of all of them. In order to clearly describe the intercompatibility of the hardware and the software, various components, blocks, modules, circuits, and steps have been generally described above in association with functions thereof. Whether the functions are implemented as the hardware or software depends on design restrictions given to a specific application and an entire system. Those skilled in the art of the present disclosure may implement functions described by various methods with respect to each specific application, but it should not be interpreted that the implementation determination departs from the scope of the present disclosure.

Various embodiments presented herein may be implemented as manufactured articles using a method, an apparatus, or a standard programming and/or engineering technique. The term manufactured article includes a computer program, a carrier, or a medium which is accessible by a predetermined (or selected) computer-readable storage device. For example, a computer-readable storage medium includes a magnetic storage device (for example, a hard disk, a floppy disk, a magnetic strip, or the like), an optical disk (for example, a CD, a DVD, or the like), a smart card, and a flash memory device (for example, an EEPROM, a card, a stick, a key drive, or the like), but is not limited thereto. Further, various storage media presented herein include one or more devices and/or other machine-readable media for storing information.

It will be appreciated that a specific order or a hierarchical structure of steps in the presented processes is one example of accesses. It will be appreciated that the specific order or the hierarchical structure of the steps in the processes within the scope of the present disclosure may be rearranged based on design priorities. Appended method claims provide elements of various steps in a sample order, but the method claims are not limited to the presented specific order or hierarchical structure.

The description of the presented embodiments is provided so that those skilled in the art of the present disclosure use or implement the present disclosure. Various modifications of the embodiments will be apparent to those skilled in the art and general principles defined herein can be applied to other embodiments without departing from the scope of the present disclosure. Therefore, the present disclosure is not limited to the embodiments presented herein, but should be interpreted within the widest range which is coherent with the principles and new features presented herein.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method for detecting a serial section of a medical image, the method performed by a computing device including at least one processor, the method comprising:
detecting segments included in at least one tissue which exists in the medical image;
estimating a number of tissue sections corresponding to the serial section and a distance between the segments based on the segments; and
identifying tissue sections corresponding to the serial section based on the estimated number of tissue sections and the estimated distance between the segments.

2. The method of claim 1, wherein the detecting the segments includes detecting the segments included in the at least one tissue which exists in the medical image by inputting the medical image in a pre-learned deep learning model.

3. The method of claim 1, wherein the detecting the segments includes:
determining candidate segments included in the at least one tissue which exists in the medical image based on an intensity of the medical image; and
determining segments corresponding to a detection object from the candidate segments based on sizes of the candidate segments.

4. The method of claim 1, wherein the estimating the number of tissue sections and the distance between the segments includes:
calculating difference values between the segments and an entire region by comparing each of the segments with the entire region of the medical image;
extracting at least one local point for each region corresponding to each of the segments based on sizes of the difference values; and
estimating the number of tissue sections corresponding to the serial section based on the local point by considering sizes of the segments.

5. The method of claim 4, wherein the extracting the at least one local point includes determining a point where the sizes of the difference values are equal to or less than a threshold in the entire region of the medical image as the at least one local point.

6. The method of claim 4, wherein the estimating the number of tissue sections corresponding to the serial section based on the local point includes estimating the number of tissue sections corresponding to the serial section by performing voting for the local point with the size of each of the segments as a weight.

7. The method of claim 1, wherein the estimating the number of tissue sections and the distance between the segments includes:
performing geometric transform for the segments;
comparing difference values between segments to which the geometric transform is applied and regions matched by the geometric transform of the segments; and
estimating the distance between the segments based on a result of the comparison.

8. The method of claim 7, wherein the estimating the distance between the segments based on the result of the comparison includes estimating the distance between the segments based on a degree at which difference values between the segments to which the geometric transform is applied and the regions matched by the geometric transform of the segments correspond to each other.

9. The method of claim 1, wherein the identifying the tissue sections corresponding to the serial section includes:
generating a graph based on the distance between the segments; and
identifying the tissue sections corresponding to the serial section by splitting the graph based on the estimated number of tissue sections.

10. The method of claim 9, wherein the graph includes:
a node with sizes of the segments as a weight; and
an edge with the distance between the segments as a weight.

11. The method of claim 9, wherein the identifying the tissue sections corresponding to the serial section by splitting the graph based on the estimated number of tissue sections includes:
splitting the graph to suit the estimated number of tissue sections according to the distance between the segments;
grouping the segments based on the graph split to suit the estimated number of tissue sections; and
identifying each segment group generated through the grouping as one tissue section.

12. A computer program stored in a non-transitory computer-readable storage medium, wherein the computer program executes operations for detecting a serial section for a medical image when the computer program is executed by one or more processors, the operations comprising:
detecting segments included in at least one tissue which exists in the medical image;
estimating a number of tissue sections corresponding to the serial section and a distance between the segments based on the segments; and
identifying tissue sections corresponding to the serial section based on the estimated number of tissue sections and the distance between the segments.

13. A computing device detecting a serial section for a medical image, the device comprising:
a processor including at least one core;
a memory including program codes executable in the processor; and
a network unit receiving a medical image,
wherein the processor:
detects segments included in at least one tissue which exists in the medical image,
estimates a number of tissue sections corresponding to the serial section and a distance between the segments based on the segments, and
identifies tissue sections corresponding to the serial section based on the estimated number of tissue sections and the distance between the segments.
